(19) United States
(12) Patent Application Publication
(10) Pub. No.: US 2014/0283648 A1
(43) Pub. Date: Sep. 25, 2014

(54) GEARBOX INTEGRATED IN ROTOR OF ELECTRICAL MOTOR

(71) Applicant: Lars Severinsson, Hishult (SE)

(72) Inventor: Lars Severinsson, Hishult (SE)

(73) Assignee: BorgWarner TorqTransfer Systems AB, Landskrona (SE)

(21) Appl. No.: 14/123,371

(22) PCT Filed: Jun. 8, 2012
(86) PCT No.: PCT/EP2012/060868

§ 371 Date: Feb. 5, 2014

(30) Foreign Application Priority Data
Jun. 8, 2011 (SE) 1150519-5
Oct. 11, 2011 (SE) 1150936-1

(51) Int. Cl. B60K 1/00; F16H 1/22

(52) U.S. Cl. CPC B60K 1/00; F16H 1/22
USPC 74/665 F; 74/421 A

(57) ABSTRACT

An electric motor has a gearbox enabling a modification of gear ratio between a main rotor of the motor and an output shaft. The gearbox is situated within a space delimited by the main rotor of the motor.

### FIELD OF THE INVENTION

The present invention relates to an electric motor having a gearbox enabling a modification of a gear ratio between a main rotor of the motor and an output shaft of the motor.

### PRIOR ART

In many cases, it is desired to modify an outgoing rotational speed of an electric motor, depending on the desired use of the rotational movement of the outgoing shaft. For achieving this, a gearbox is usually installed in series with the electrical motor. The gearbox may be of the planetary type or any other type, but planetary gear type gearboxes are often preferred due to their compactness. The start motor of a car engine is usually provided with a planetary gear type gearbox, which decreases the rotational speed of the motor (and increases the torque accordingly) to a torque and a rotational speed suitable for starting the engine.

Another growing use for electric motors in vehicles is as drive sources, e.g. in hybrid or fully electric vehicles. For these purposes, it has been found that it is beneficial if the gear ratio between the motor and the drive wheels can be altered responsive to the vehicle speed. An electric motor has a large motor speed span, but by using a gearbox having various gear ratios, it is possible to achieve a driveline with a high initial drive torque, while the motor does not run at too high a motor speed at high vehicle speed. Moreover, by reducing the motor speed, large efficiency benefits, along with reduced wear of bearings and the like, may be earned. The benefits are gained by reducing electromagnetic losses, cooling fan losses and friction losses. By providing a gearbox having high a low gear, it is also possible to apply a large torque at the driving wheels at low vehicle speeds.

There are many gearbox/motor assemblies marketed today. All these gearbox/motor assemblies have in common that the gearbox and the motor are mounted in series, i.e. the gearbox is mounted as an elongation of the motor. This leads to a size increase, either on the length or the width of the gearbox/motor assembly.

EP 2 226 211 discloses an electric motor having a differential housed within a rotor of the motor. There is, however, no gearbox included in the motor/differential assembly.

It is the object of the present invention to provide an electric motor/gearbox assembly having a small size.

It is also an object of the present invention to provide an electric motor/gearbox assembly having an integrated differential.

### SUMMARY OF THE INVENTION

The above and other problems are solved by an electric motor having a gearbox enabling a modification of a gear ratio between a rotor of the motor and an output shaft, wherein the gearbox is situated within a space delimited by the main rotor of the motor.

In order to control the motor speed at a certain speed of the output shaft, the gearbox may me actuated to provide two different gear ratios from the rotor to the output shaft.

The gearshifts between the two different gear ratios may be effected by engaging a first or a second clutch assembly.

This may for example be achieved in that an engagement of the first clutch assembly directly connects the rotor and the output shaft and an engagement of the second clutch assembly connects the rotor to the output shaft via a hollow shaft, at least one dual diameter tooth wheel and a tooth wheel on the output shaft.

In order to effect a smooth gear shift, the clutch assemblies may be clutch assemblies comprising a number of friction discs arranged such that engagement of either of the first and second clutch assemblies automatically disengages the clutch assembly not being engaged.

In order to increase the efficiency of the gear assembly by eliminating drag losses in the friction rings in the clutch, the clutch assemblies may comprise first and second toothed clutch wheels and an internally toothed clutch ring, wherein the clutch ring is movable between engagement between the first and second tooth wheels, there being an idling position between the first end second gear wheels, such that the internally toothed clutch ring is not engaged to neither the first nor the second toothed clutch wheel.

The present invention also relates to an electrical drive axle of a four wheeled road vehicle, the drive axle comprising an electric motor having a gearbox enabling a modification of a gear ratio between a rotor of the motor and an output shaft, wherein the gearbox is situated within a space delimited by the main rotor of the motor.

In order to be able to omit gears and the like, the electric motor may be arranged coaxially on said axle.

In order to increase the fraction of the vehicle, a torque vectoring unit comprising an electrical motor ma be arranged coaxially on said axle for providing a change in torque distribution between said first side and said second side of said axle.

### BRIEF DESCRIPTION OF THE DRAWINGS

In the following, the invention will be described with reference to the appended drawings, wherein:

FIG. 1 is a perspective view showing components of a first embodiment of a gearbox comprised in a motor according to the present invention;

FIG. 2 is an exploded view showing the embodiment of FIG. 1;

FIG. 3 is a section view of the embodiment shown in FIGS. 1 and 2,

FIG. 4 is a perspective view identical to the view of FIG. 1, however showing a second embodiment of the gearbox comprised in the motor according to the invention;

FIG. 5 is an exploded view identical to the view of FIG. 2, of the embodiment of FIG. 4;

FIG. 6 is a view identical to the view of FIG. 3, but showing the embodiment of FIGS. 4 and 5.

FIG. 7 is a section view showing a motor having a gearbox according to the invention connected to a differential with a torque vectoring function.

### DESCRIPTION OF EMBODIMENTS

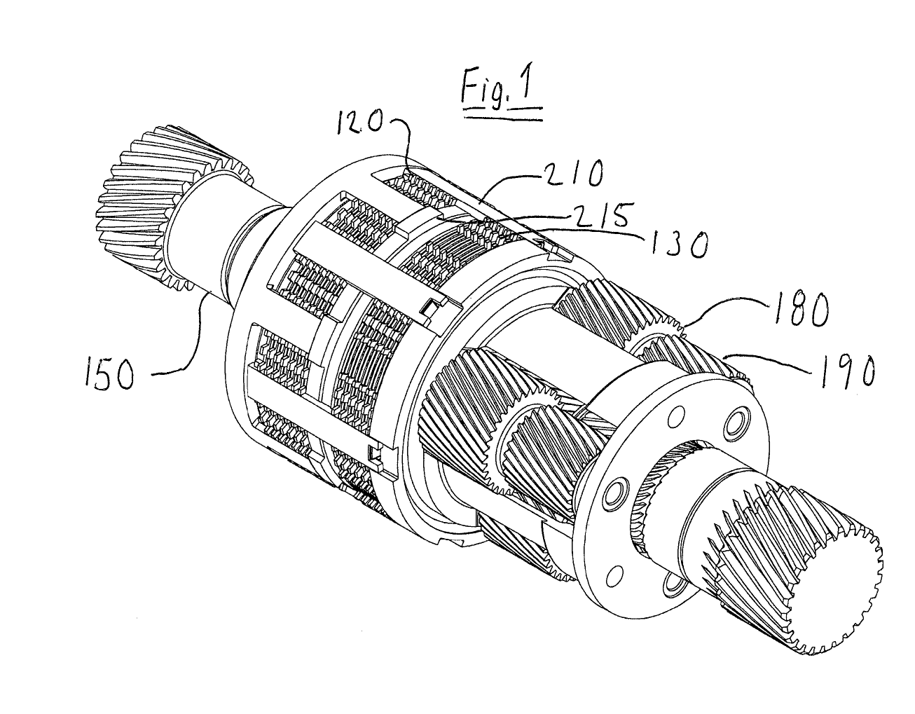

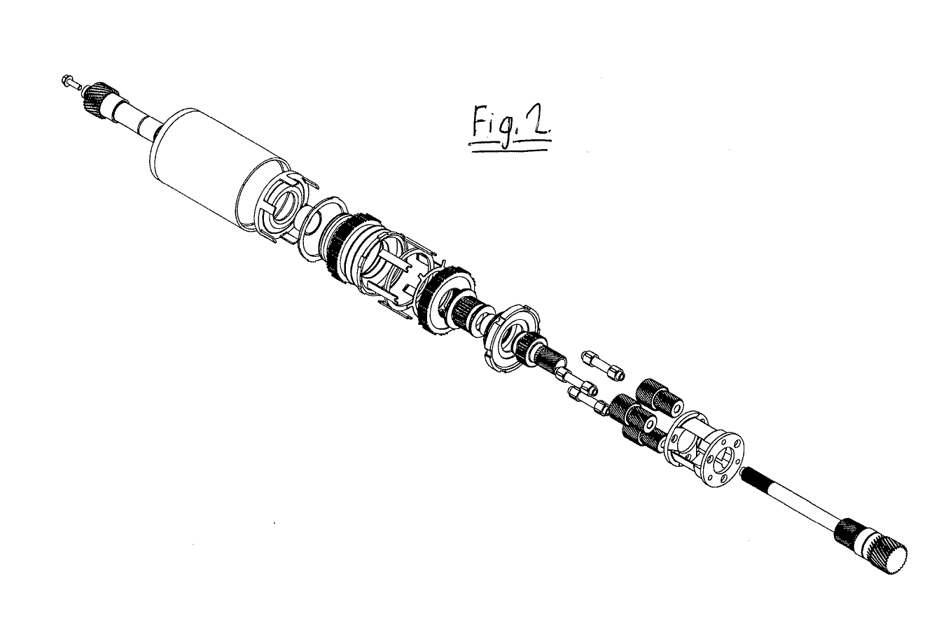

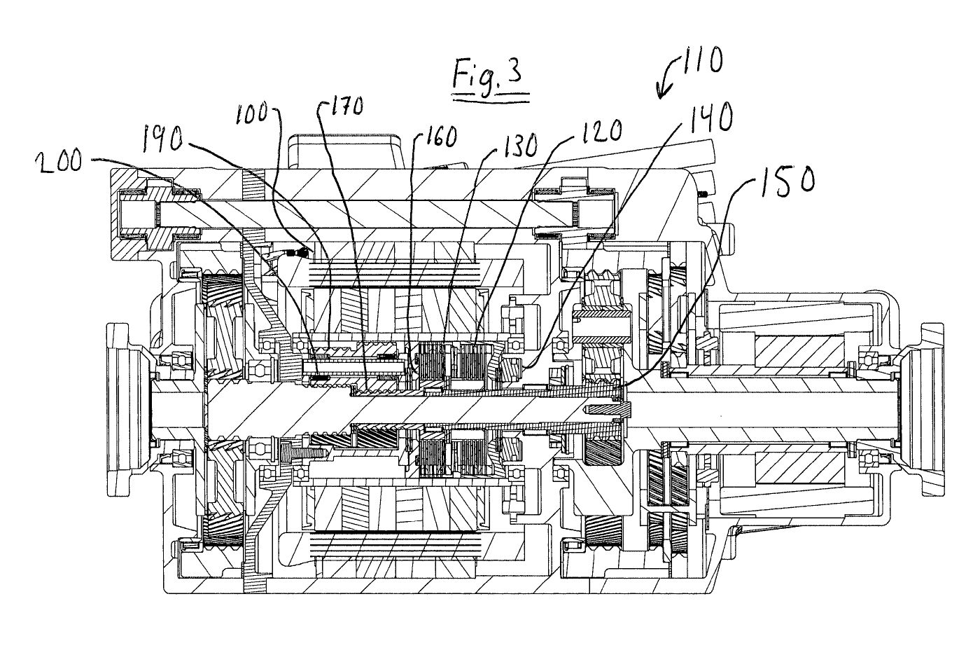

With reference to FIGS. 1-3, a gearbox located within a space of a rotor 100 of an electric motor 110 is shown. The gearbox comprises a first clutch 120, a second clutch 130, wherein the first clutch upon engagement transfers torque from the rotor directly to an output shaft 150 and the second clutch transfers torque from the rotor to the output shaft via a gearbox fitted within the space of the rotor 110 in a way to be described later. A clutch actuator 140 decides whether the first clutch or the second clutch is engaged.

As implied above, the second clutch transfers torque from the rotor to the gearbox. This is done via a hollow toothed shaft 160, which is journalled on the output shaft, such that relative rotation between the output shaft and the toothed shaft 160 is allowed. The toothed shaft 160 is engaged to a first toothed surface 170 of a dual tooth wheel 180. A second toothed surface 190 of the dual tooth wheel 180 is engaged to a toothed surface 200 of the output shaft.

The first and second clutches are configured such that they will not be engaged simultaneously. By operating the clutch actuator, a user can decide which of the clutches that will be engaged. By default, if one clutch is engaged, the other will be disengaged. This is accomplished by the cooperation between the clutches and the clutch actuator; the clutch actuator will upon actuation compress the second clutch such that it will transfer torque from the rotor to the hollow shaft 160, and in the same time relieve the first clutch from compression, such that it will not transfer any torque. If the clutch actuator is not actuated, a spring 165 will compress the first clutch and relieve the second clutch from compression, such that the first clutch will transfer torque directly to the output shaft, whereas the second clutch will not transfer any torque to the hollow shaft.

Above is a rather short summary of the function of the present invention. Below, a more detailed description will be given.

With reference to FIG. 1, the gear to be situated within a space delimited by the rotor of an electric motor is shown. The first 120 and second 130 clutches are located within a basket 210, a central portion of which being provided with teeth 215, which are operatively connected with grooves (not shown) in an internal surface of the rotor, such that the teeth 215 are free to slide in a longitudinal direction, but forced to corotate with the rotor. The actuator 140 (not shown in FIG. 1) is also connected to the basket 210, such that either of the first or second clutches will transfer torque from the rotor, via the basket 210, to the either the output shaft or the hollow shaft.

If the clutch actuator is actuated to direct torque to the hollow shaft 160, the torque will lead to the hollow shaft 160 rotating in a direction equal to the direction of the rotor. The engagement to the hollow shaft will cause the dual tooth wheels 180 to rotate in a direction opposite to the rotor; however, when the other toothed surface of the dual tooth wheel cooperates with the toothed surface 200 of the output shaft, the driving direction on the output shaft will be equal to the rotor rotational direction.

In the shown embodiment, three dual tooth wheels 180 are shown. The number of dual tooth wheels is however totally irrelevant for the understanding of the invention, in some cases it might be necessary to provide more dual tooth wheels, in some cases it might be possible to omit one or two of the wheels, such that only one or two dual tooth wheels are provided. The reasons for having more than one dual tooth wheel is that the radial load on the hollow bearing and the hollow shaft is reduced and that the transferable torque is increased. Also, the load on each tooth wheel contact will decrease. One embodiment that may be wise to avoid comprises only one dual tooth wheel; if only one dual tooth wheel is used, there will be lateral force acting on the hollow shaft 160, a lateral force that is avoided if more than one dual tooth wheel is used.

In the shown embodiment, the toothed surface 170 of the hollow shaft has a smaller diameter than the toothed surface 200 (and the toothed surfaces of the dual tooth wheel are correspondingly smaller and larger, respectively). This leads to a reduction in the rotational speed of the output shat with respect to the rotor when the second clutch 130 is engaged and the first clutch 120 is disengaged. This is, however, easy to alter, should a higher rotational speed of the output shaft compared to the main rotor be desired, simply by changing the diameters of the toothed surface of the hollow shaft, the toothed surfaces of the dual torque wheels and the toothed surface 200 of the output shaft.

In case the first clutch 120 is engaged and the second clutch 130 is disengaged, the toothed surface 200 of the output shaft will drive the dual tooth wheels to rotate, and the hollow shaft 160 will be driven by the dual tooth wheels. However, since the second clutch 130 is not engaged, no torque will be transferred over this clutch.

If the gearbox is configured to reduce the speed from the rotor to the output shaft (such as disclosed above), then the hollow shaft will rotate in a higher speed than the rotor speed if the first clutch is engaged and the second clutch is disengaged. Unfortunately, this leads to some energy losses due to friction in the second clutch, since the discs of this clutch will rotate in different velocities.

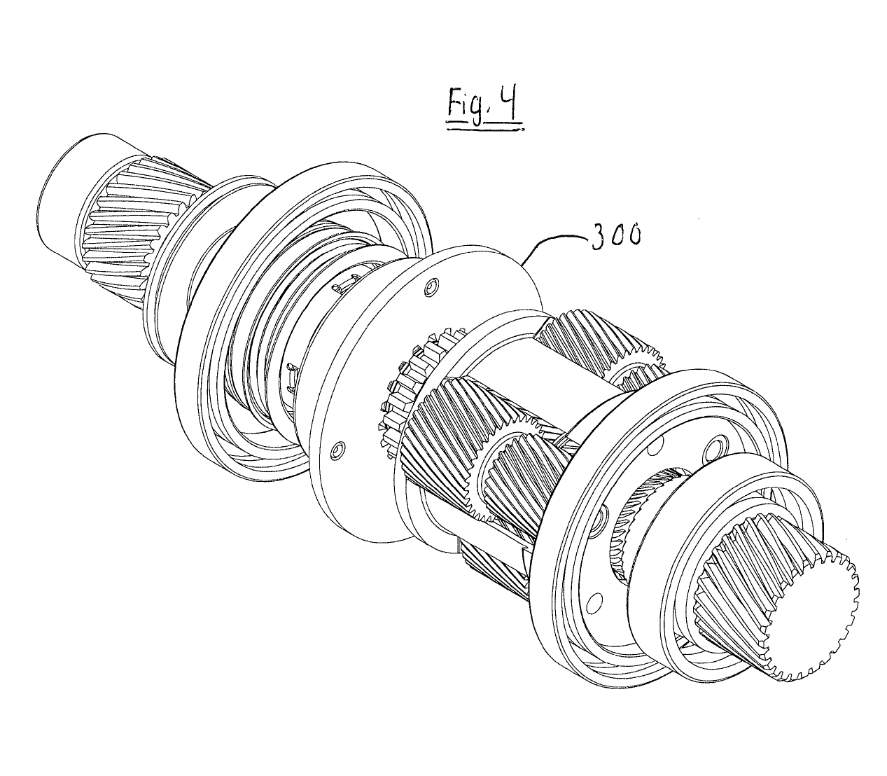

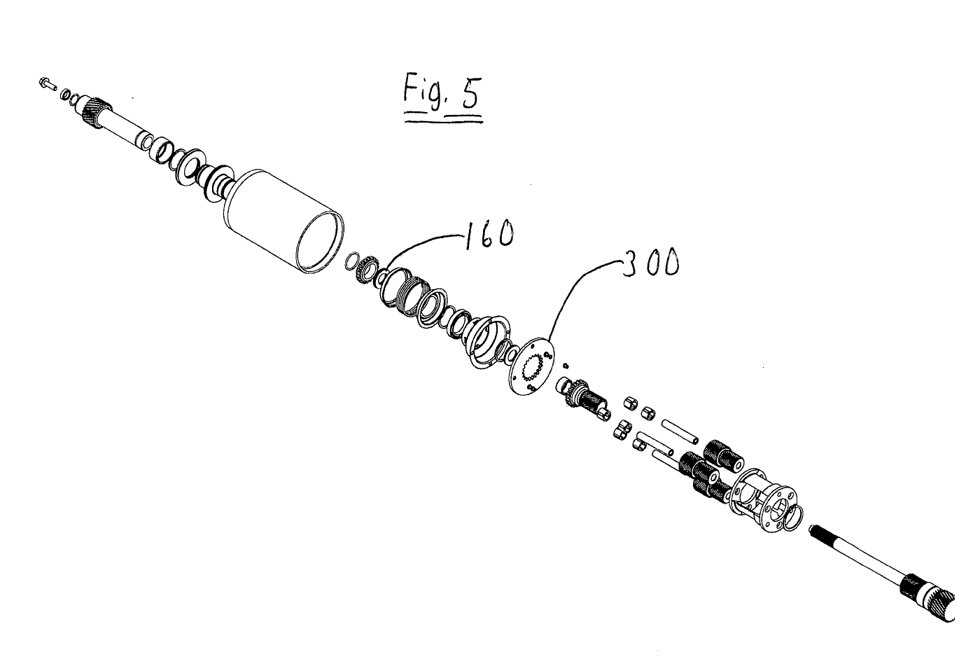

In order to alleviate the problem with energy losses in the second clutch, it is possible to use an alternative embodiment of the present invention, which is shown in FIGS. 4-6. This embodiment is identical to the previously disclosed embodiment except for the first 120 and second 130 clutches, the function of which being replaced by a clutch assembly comprising an internally toothed clutch ring 300, the internal teeth of which being in contact with splines on the hollow shaft and which is movable between engagement with first 310 and second 320 toothed clutch wheels, which are connected to the hollow shaft 170 and the output shaft 150 in the same manner as the first and second clutches 120, 130, respectively, of the first embodiment.

The clutch ring 300 can be moved in an axial direction by an actuator 330, which is connected to the clutch ring 300 via a spring 340. The spring 340 will urge the clutch ring in the desired direction as the actuator 340 is actuated.

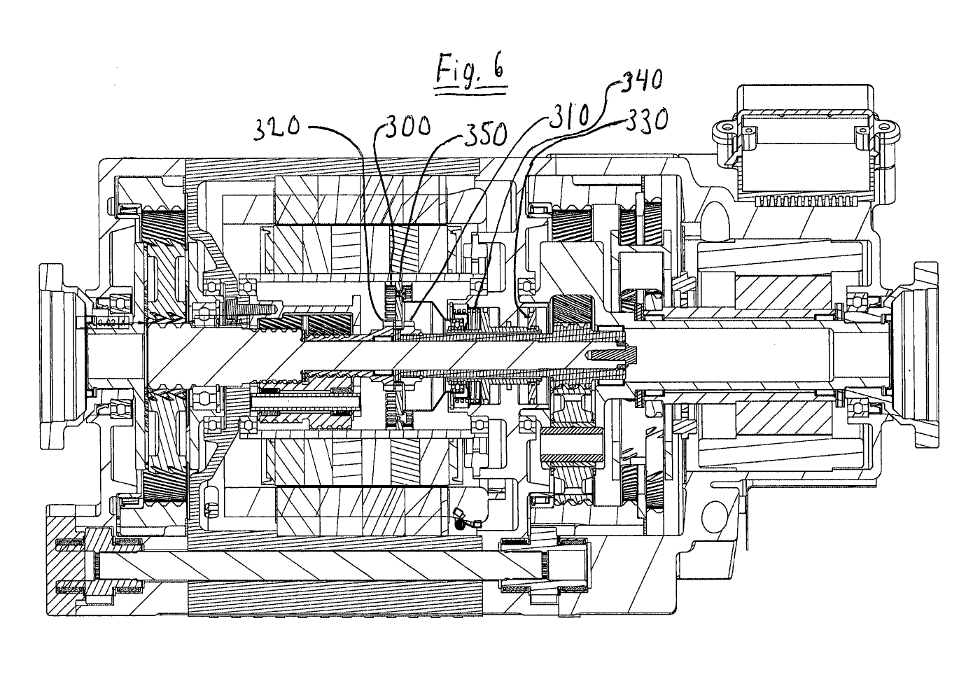

As can be seen in FIGS. 4 and 6, there is a space 350 between the first 310 and second 320 toothed clutch wheels. This is space is necessary for allowing gear shift during operation of the motor, since in all cases, the rotational speed of the first 310 and second 320 toothed clutch wheels will be different. By providing a space between the first 310 and second 320 toothed clutch wheels, there will be an idling position, i.e. a position wherein no torque will be transferred, of the gear if the clutch ring 300 is positioned in this space.

One benefit of this embodiment is that the idling position of the clutch ring actually can be used; as mentioned, the friction losses are very small for this embodiment, which makes it possible to detach the motor from rotation with the drive wheels. In the shown embodiment, the clutch ring can be moved by actuating either of the actuators 320 or 330; of none of the actuators is actuated, the clutch ring will assume the neutral position.

In order to shift gear, or connect a gear from the neutral position, it is crucial that the rotational speed of the clutch wheel to be engaged is identical or close to identical to the rotational speed of the clutch ring. This could either be accomplished by controlling the motor speed to a value corresponding to the rotational speed of the clutch wheel to be engaged, but it could also be accomplished by provision of synchronization rings, which are designed such that a friction force will accelerate or decelerate the motor before the clutch ring and the clutch wheel are engaged. Moreover, the synchronization rings have the function of not allowing engagement of the clutch ring and the clutch wheel until the clutch ring and the clutch wheel have identical or similar rotational speed. The function of synchronization rings is well known by persons skilled in the art, and will hence not be more thoroughly described.

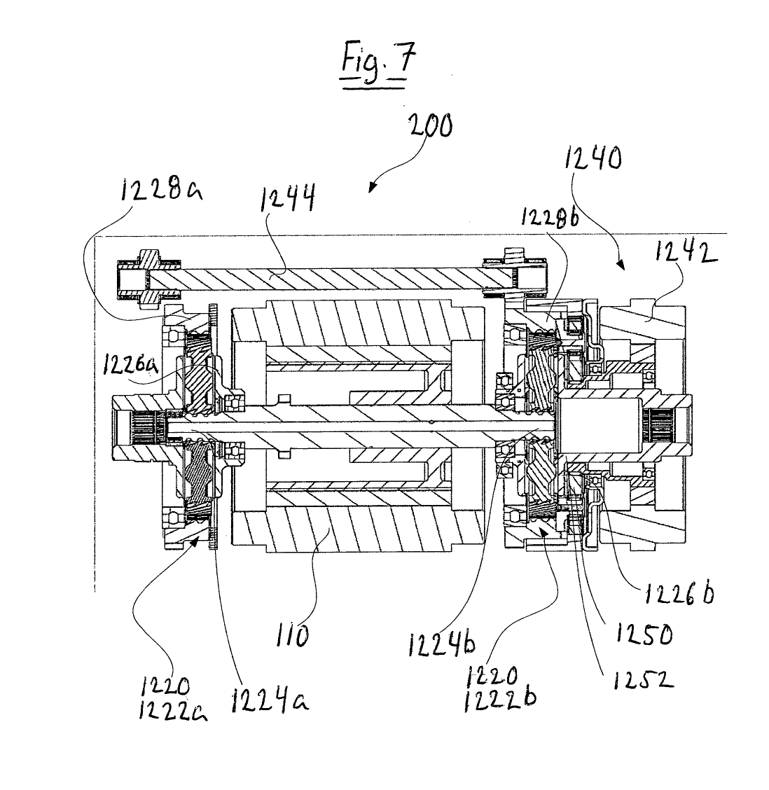

The electric motor described above is preferably installed in a drive train of a vehicle, such as a car, lorry, bus or the like. One portion of a drive train according to the invention is shown in FIG. 7, and includes the electric motor 110 driving a differential which is connected to a left wheel shaft and a right wheel shaft, respectively (not shown), the differential allowing for different wheel speeds, that may be necessary while turning a vehicle having two drive wheels at the same axle. Further, a torque vectoring unit may provided for providing a torque difference between the two wheel shafts. Torque vectoring is especially useful should one of the drive wheels lose its traction; if no torque vectoring possibility is present, all drive torque will get lost in the spinning wheel, since a differential makes sure the same torque is transferred to both wheels on a drive axle; if a wheel is spinning, the torque needed to rotate that wheel will of course be reduced significantly; hence, the other wheel on the same axle will only transmit as much torque as is needed to spin the spinning wheel.

With reference to FIG. 7, an electrical axle 1000, which includes the electrical propulsion motor 110 having a gearbox according to the invention integrated within the space delimited by the main rotor , a differential mechanism 1220 and a torque vectoring device 1240 is configured to be connected to the left wheel shaft and the right wheel shaft (not shown). The electrical propulsion motor 110 is preferably arranged coaxially with the axle 1000, and is connected on each lateral side to a differential mechanism 1220 comprising two coaxially aligned planetary gears 1222a, 1222b, wherein the electrical propulsion motor 1210 drives the sun gears 1224a, 1224b. The left and right wheel shafts are connected to the planetary carriers 1226a, 1226b of the respective planetary gears 1222a, 1222b. The ring gear 1228a, 1228b of the respective planetary gear 1222a, 1222b has an outer surface which is connectable, e.g. by means of teeth, to the torque vectoring device 1240.

The torque vectoring device 1240 includes an electrical motor 1242 arranged coaxially with the axle 1200, such that the rotational axis of the motor 1242 is aligned with the rotational axis of the electrical propulsion motor 110. The electrical motor 1242 is further arranged distally of the differential mechanism 1220, i.e. between one of the planetary gears 1220a, 1200b and the adjacent wheel shaft.

The electrical motor 1242 of the torque vectoring device 1240 may be connected directly to the ring wheel 1228b of the second planetary gear 1222b, and connected to the ring wheel 1228a of the first planetary gear 1222a via a rotatable balancing shaft 1244 extending parallel with the axle 1200, and provided with gears for engagement with the ring gear 1228a of the planetary gear 1222a. The gears of the balancing shaft 1244 are configured for transmitting torque to the planetary gear 1222a upon rotation of the balancing shaft 1244, wherein the torque transmitted to the planetary gear 1222a has an opposite direction compared to the torque transmitted to the other planetary gear 1222b by the electrical propulsion motor 110.

The ring wheels 1228a, 1228b may further be connected to the electrical motor 1242 of the torque vectoring device via a gear reduction. The gear reduction may be a cycloidal drive, a differential planetary gear, a double cycloidal drive, or a multi-cycloidal drive comprising three or more discs which are arranged on the rotational shaft of the electrical motor. These kinds of gear reductions are described in the co-pending application PCT/EP2011/070253 by the same applicant.

In a yet further embodiment the gear reduction is omitted, such that the electrical motor of the torque vectoring unit is connected directly the ring wheel of the second planetary gear of the differential mechanism, and to the ring wheel of the second planetary gear of the differential mechanism via the balancing shaft. Such embodiment is advantageous in that fewer components are used, although it requires extreme performance of the electrical motor.

It will be appreciated that the embodiments described in the foregoing may be combined without departing from the scope as defined by the appended claims.

Although the present invention has been described above with reference to specific embodiments, it is not intended to be limited to the specific form set forth herein. Rather, the invention is limited only by the accompanying claims and, other embodiments than the specific above are equally possible within the scope of these appended claims. Especially, it is possible to freely combine features described in the different embodiments above without departing from the scope of the invention.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. An electric motor having a gearbox enabling a modification of gear ratio between a main rotor of the motor and an output shaft, wherein the gearbox is situated within a space delimited by the main rotor of the motor.

2. The electric motor of claim 1, wherein the gearbox constructed and arranged to actuate to two different gear ratios from the rotor to the output shaft.

3. The electric motor of claim 2, wherein gearshifts between the two different gear ratios are provided by engaging a first or a second clutch assembly.

4. The electric motor of claim 3, wherein an engagement of the first clutch assembly directly connects the rotor and the output shaft.

5. The electric motor of claim 3, wherein an engagement of the second clutch assembly connects the rotor to the output shaft via a hollow shaft, at least one dual diameter tooth wheel and a tooth wheel on the output shaft.

6. The electric motor of claim 3, wherein the clutch assemblies are clutch assemblies comprising a number of friction discs.

7. The electric motor of claim 3, wherein the clutch assemblies comprise first and second toothed clutch wheels and an internally toothed clutch ring, wherein the clutch ring is movable between engagement between the first and second tooth wheels.

8. An electric drive axle of a four wheeled road vehicle, comprising an electric motor according to claim 1.

9. The drive axle according to claim 8, wherein said electric motor is arranged coaxially on said axle.

10. The drive axle according to claim 8, further comprising a torque vectoring unit comprising an electrical motor arranged coaxially on said axle for providing a change in torque distribution between said first side and said second side of said axle.

11. The drive axle according to claim 9, further comprising a torque vectoring unit comprising an electrical motor arranged coaxially on said axle for providing a change in torque distribution between said first side and said second side of said axle.

12. The electric motor of claim 3, wherein an engagement of the second clutch assembly connects the rotor to the output shaft via a hollow shaft, at least one dual diameter tooth wheel and a tooth wheel on the output shaft.

13. The electric motor of claim 4, wherein the clutch assemblies are clutch assemblies comprising a number of friction discs.

14. The electric motor of claim 5, wherein the clutch assemblies are clutch assemblies comprising a number of friction discs.

15. The electric motor of claim 4, wherein the clutch assemblies comprise first and second toothed clutch wheels and an internally toothed clutch ring, wherein the clutch ring is movable between engagement between the first and second tooth wheels.

16. The electric motor of claim 5, wherein the clutch assemblies comprise first and second toothed clutch wheels and an internally toothed clutch ring, wherein the clutch ring is movable between engagement between the first and second tooth wheels.
